(19) United States
(12) Patent Application Publication
(10) Pub. No.: US 2007/0232174 A1
(43) Pub. Date: Oct. 4, 2007

(54) Polybutylene naphthalate filtration media

(76) Inventors: Arvind Karandlkar, Morristown, TN (US); Bing Lu, Union, KY (US)

Correspondence Address: TICONA LLC, 8040 DIXIE HIGHWAY, FLORENCE, KY, 41042, US

(21) Appl. No.: 11/394,396

(22) Filed: Mar. 31, 2006

(51) Int. Cl. D04H 13/00; D04H 5/00; B32B 5/26; D04H 1/56; B32B 29/02

(52) U.S. Cl. 442/340; 442/381; 442/400; 442/341; 442/412

(57) ABSTRACT

This invention is based upon the discovery that polybutylene naphthalate resin (PBN) having an intrinsic viscosity which is within the range of 0.3 to 0.7 dl/g can be easily processed into a nonwoven web of meltblown or spunbond fibers that exhibit excellent characteristics for utilization in making filtration media, such as strength, durability and filtration efficiency. Additionally, such a nonwoven web of meltblown or spunbond fibers offers outstanding resistance to organic liquids, such as gasoline, gasohol, kerosene, diesel fuel, jet fuel, motor oil and the like. Filtration media manufactured utilizing such polybutylene naphthalate also offers excellent heat resistance, chemical resistance, acid resistance, and alkali resistance. The present invention more specifically discloses a filtration media that is comprised of a nonwoven web of fibers having an average diameter which is within the range of about 0.5 microns to about 35 microns, wherein the fibers are comprised of polybutylene naphthalate having an intrinsic viscosity which is within the range of 0.3 to 0.7 dl/g as measured in o-chlorophenol at 35° C.

### FIELD OF THE INVENTION

This invention relates to filtration media that is made of nonwoven meltblown or spunbond fibers that are comprised of polybutylene naphthalate.

### BACKGROUND OF THE INVENTION

Nonwoven webs of meltblown or spunbond fibers are frequently utilized as filtration media for utilization manufacturing filters for liquids and/or gasses. Such meltblown nonwoven webs can be made by a meltblowing process that involves extruding a thermoplastic resin through a row of closely spaced orifices to form a plurality of polymer filaments (or fibers) while converging sheets of high velocity hot air impart drag forces on the filaments and draw them down to microsized diameters. The microsized fibers are blown onto a collector screen or conveyor where they are entangled and collected, forming the integrated nonwoven web. The average diameter size of the fibers in the web typically ranges from about 0.5 microns to about 20 microns. The integrity or strength of the web depends upon the mechanical entanglement of the fibers as well as fiber bonding.

A wide variety of thermoplastic resins are known to be useful in manufacturing such meltblown and spunbond nonwoven webs for filtration media. These thermoplastic resins include polyamides, polyesters, polycarbonates, polyarylates, polyolefins, polyurethanes, polyethers, and polyacrylates. U.S. Pat. No. 6,322,604 reports that it is desirable for such filter media to be comprised of a thermoplastic polyester such as, polyethylene terephthalate (PET), polybutylene terephthalate (PBT), and polytrimethylene terephthalate. The selection of the particular polymer or polymers will vary with the intended application of the filter as well as other factors.

Meltblown nonwoven fabrics have been used in a variety of filtration applications. For instance, nonwoven webs of polyester fiber have been used in bag filters and vacuum cleaner filters as described in U.S. Pat. No. 5,080,702, U.S. Pat. No. 5,205,938, and U.S. Pat. No. 5,586,997. Nonwoven webs of polyester fiber have also been used for filtering biological fluids as described in U.S. Pat. No. 5,652,050.

One shortcoming of meltblown nonwoven fiber webs is that they often lack the strength and/or tenacity required for utilization in certain uses or applications. To overcome this problem one or more durable fabrics are sometimes laminated to the meltblown nonwoven fiber web to attain a laminate structure with improved overall characteristics. For example, U.S. Pat. No. 4,041,203 describes a nonwoven fabric-like material comprising a web of substantially continuous and randomly deposited, molecularly oriented filaments of a thermoplastic polymer having an average filament diameter in excess of about 12 microns and an integrated mat of generally discontinuous, thermoplastic polymeric microfibers having an average fiber diameter of up to about 10 microns. This nonwoven fabric-like material is reported to be useful as a sterile wrapper or containment fabric for surgical or other health care procedures and for used in garments and wipes. U.S. Pat. No. 5,667,562 describes a durable spunbond/meltblown nonwoven laminate structure which takes advantage of the filtration or barrier properties of the meltblown fabric and the improved strength and durability of the spunbond fabric.

While many nonwoven polyester fabrics exhibit excellent strength and durabilty, polyester meltblown nonwovens fabrics generally do not exhibit high strength and durability since the meltblowing process does not adequately draw the fibers so as to significantly promote crystallization of the polymer. Thus, it is likewise known in the art to improve the strength and durability of meltblown polyester materials by laminating a separate durable fabric thereto such as, a spunbond fiber web or other suitable supporting fabric. As a particular example, meltblown polyester nonwoven webs can be laminated with durable fabrics such as high strength polyester filaments. The polyester filaments have improved strength since they have undergone separate drawing steps which orient the polymer thereby improving the strength and tenacity of both the fibers and the fabric made therefrom. The meltblown fiber web and the drawn fibers may be thermally point bonded to one another. However, it should be noted that utilizing one or more support layers can significantly increase the overall cost of the laminate.

Multilayer laminates can offer excellent strength and durability. However, the means for permanently bonding the individual layers together can adversely impact the efficiency and service life of the filtration media. For instance, spunbond and meltblown nonwoven fiber webs are often thermally point-bonded. The bonded areas are highly fused areas which allow little, if any, penetration of the fluid to be filtered. Thus, the bond areas reduce the effective area of the filter and increase pressure drop across the filter media. In addition, use of adhesives and other bonding methods can likewise negatively impact filter efficiency and/or life. Thus, improved abrasion resistance and/or laminate integrity achieved in this manner often comes at the expense of overall permeability and/or filtration efficiency. Consequently, the ability to achieve such improved properties without sacrificing other desired attributes of the filter media has proven difficult.

It would be commercially beneficial to have a filter media that exhibits improved strength, durability, and filtration efficiency that can be manufactured with meltblown or spunbond fibers. The development of a nonwoven filter media that was resistant to organic liquids, such as gasoline, gasohol, kerosene, diesel fuel, jet fuel, motor oil and the like would be even more desirable.

### SUMMARY OF THE INVENTION

This invention is based upon the discovery that polybutylene naphthalate resin (PBN) having an intrinsic viscosity which is within the range of 0.3 to 0.7 dl/g can be easily processed into a nonwoven web of meltblown or spunbond fibers that exhibit excellent characteristics for utilization in making filtration media, such as strength, durability and filtration efficiency. Additionally, such a nonwoven web of meltblown or spunbond fibers offers outstanding resistance to organic liquids, such as gasoline, gasohol, kerosene, diesel fuel, jet fuel, motor oil and the like. Filtration media manufactured utilizing such polybutylene naphthalate also offers excellent heat resistance, chemical resistance, acid resistance, alkali resistance, and hydrolysis resistance. The filtration media also offers outstanding capability to hold an electrostatic charge for extended time periods. This is a valuable benefit in manufacturing air filters since dirt in air carries an electrical charge.

The present invention more specifically discloses a filtration media that is comprised of a nonwoven web of fibers having an average diameter which is within the range of about 0.5 microns to about 35 microns, wherein the fibers are comprised of polybutylene naphthalate having an intrinsic viscosity which is within the range of 0.3 to 0.7 dl/g as measured in o-chlorophenol at 35° C.

The subject invention further reveals a filter comprising a rigid frame having a filtration media fixedly attached thereto, wherein the filtration media is comprised of a nonwoven web of fibers having an average diameter which is within the range of about 0.5 microns to about 35 microns, wherein the fibers are comprised of polybutylene naphthalate having an intrinsic viscosity which is within the range of 0.3 to 0.7 dl/g as measured in o-chlorophenol at 35° C. It is desirable for the frame to also be comprised of polybutylene naphthalate. This makes the filter more easily recyclable into other articles of manufacture that can be made employing polybutylene naphthalate. The polybutylene naphthalate utilized in making the frame can be identical to the polymer used in making the nonwoven web of fibers or it can be of a higher molecular weight.

The present invention also discloses a filter comprising: a frame having a nonwoven filter material fixedly attached thereto; said nonwoven filter material comprising (i) a first layer of polybutylene naphthalate microfibers having an average fiber size of less than about 8 micrometers and (ii) a second layer comprising polybutylene naphthalate fibers having fibers having an average fiber size in excess of 12 micrometers and wherein said second layer is autogenously bonded to said first layer, wherein said second layer has a basis weight of less than 34 g/m², and wherein the polybutylene naphthalate has an intrinsic viscosity which is within the range of 0.3 to 0.7 dl/g as measured in o-chlorophenol at 35° C.

The subject invention further reveals a process for manufacturing filter media which comprises (1) extruding molten polybutylene naphthalate through a plurality of die capillaries as molten filaments into converging high velocity gas streams that attenuate the filaments to reduce their diameter to within the range of about 0.5 microns to about 35 microns, wherein the polybutylene naphthalate has an intrinsic viscosity which is within the range of 0.3 to 0.7 dl/g as measured in o-chlorophenol at 35° C., (2) collecting the filaments on a conveyor wherein they become entangled to form a nonwoven web, and (3) allowing the entangled nonwoven web to solidify to produce a nonwoven web of the filter media.

### DETAILED DESCRIPTION OF THE INVENTION

In the practice of this invention filtration media and filters made with such media can be manufactured utilizing standard techniques with polybutylene naphthalate having an intrinsic viscosity which is within the range of 0.3 to 0.7 dl/g, as measured in o-chlorophenol at 35° C., being utilized to produce the meltblown or spunbond fibers employed in the filtration media utilized therein. For instance, the manufacturing techniques described in U.S. Pat. No. 5,273,565 and U.S. Pat. No. 6,322,604 can be employed in producing the meltblown or spunbond fibers that are employed in making the filter media and filters of this invention. It is, of course, necessary to substitute polybutylene naphthalate having an intrinsic viscosity which is within the range of 0.3 to 0.7 dl/g for the thermoplastic resins described in these conventional techniques. In any case, the teachings of U.S. Pat. No. 5,273,565 and U.S. Pat. No. 6,322,604 are incorporated herein by reference in their entirety.

The polybutylene naphthalate used in the practice of this invention has an intrinsic viscosity which is within the range of 0.3 to 0.7 dl/g as measured in o-chlorophenol at 35° C. and will more typically have an intrinsic viscosity which is within the range of 0.4 to 0.6 dl/g. The polybutylene naphthalate will have an intrinsic viscosity of at least 0.3 dl/g to provide the nonwoven web with sufficient strength to be useful as filtration media. On the other hand, the polybutylene naphthalate becomes difficult or impossible to meltblow into continuous fibers at intrinsic viscosities of greater than 0.7 dl/g.

The intrinsic viscosity of the polybutylene terephthalate is determined as follows. The viscosity, η, of a series of dilute solutions of the polybutylene naphthalate in o-chlorophenol at 35° C. is compared to that of the o-chlorophenol solvent, η₀, by the equation:
ηₛₚ/c=((η−η₀)/η₀)/c
wherein the specific viscosity, ηₛₚ, divided by the concentration, c, is termed the viscosity number. Intrinsic viscosity is defined as ηₛₚ/c at infinite dilution (zero concentration). Since ηₛₚ/c increases linearly as a function of concentration, it is possible to determine the value of ηₛₚ/c at infinite dilution by extrapolation to zero concentration.

The polybutylene naphthalate is generally prepared by reacting dimethyl 2,6-naphthalate with 1,4-butanediol through ester-interchange and polycondensation reactions. In this preparation, a third component or a mixture of third components in an amount of not more than 20 mole percent can be added before completion of the polycondensation. Suitable third components that can be utilized in the synthesis of the polybutylene naphthalate resin include dicarboxylic acids such as terephthalic acid, isophthalic acid, 2-methylterephthalic acid, 4-methylisophthalic acid, dichloroterephthalic acid, dibromoterephthalic acid, 5-sodiumsulfoisophthalic acid, naphthalate-2,7-dicarboxylic acid, diphenyldicarboxylic acid, diphenyl ether dicarboxylic acid, diphenylsulfonedicarboxylic acid, diphenoxyethanedicarboxylic acid or sebacic acid, hydroxy acids such as p-.beta.-hydroxyethoxybenzoic acid, fumctional derivatives of these acids, dihydroxy compounds such as ethylene glycol, diethylene glycol, propylene glycol, trimethylene glycol, hexamethylene glycol (tetramethylene glycol when the glycol component is hexamethylene glycol), decamethylene glycol, neopentylene glycol, cyclohexanedimethylol, hydroquinone, bis(β-hydroxyethoxy)benzene, bisphenol A, bis(p-hydroxyphenyl)sulfone, bis (p-β-hydroxyethoxy phenyl)sulfone, polyoxyethylene glycol, polyoxypropylene glycol, or polyoxytetramethylene glycol, or functional derivatives of these dihydroxy compounds. A compound having at least three ester-forming functional groups, such as glycerine, pentaerythritol, trimethylol propane, trimellitic acid, trimesic acid or pyromellitic acid, can also be incorporated in such quantities as will maintain the polymer in substantially linear polymer chains (that is to say, as will not cause cross-linkage). A monofunctional compound such as benzoic acid or naphthoic acid can also be incorporated in order to adjust the degree of polymerization of the polymer.

The polybutylene naphthalate used in this invention may also contain a delusterant such as titanium dioxide, a stabilizer such as phosphoric acid, phosphorous acid, phosphonic acid or an ester of any of these, an ultraviolet absorbent such as a benzophenone derivative or benzotriazole derivative, an anti-oxidant, a lubricant, a pigment or a filler. As the filler, other polymers such as polyethylene terephthalate, poly(ethylene-2,6-naphthalate), polytetramethylene terephthalate can also be used.

The polybutylene naphthalate used in accordance with this invention is typically comprised of repeat units that result from the condensation reaction of butylene glycol with naphthalene-2,6-dicarboxylic acid. Such polybutylene naphthalate is of the structural formula:

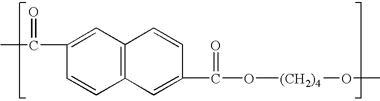

It is preferred for the filters of this invention to be comprised of at least two layers as depicted in U.S. Pat. No. 6,322,604. These layers include a first layer of fine fibers or microfibers and a second layer of larger fibers or macrofibers. The first layer is desirably a relatively thicker layer having a small average pore size and good filtration and/or barrier properties. The filter material is typically made in the form of a sheet and can readily be stored in roll form. Thus, the filter material can be subsequently converted as desired to provide a filter specifically tailored to meet the needs of the end user. However, the filter material can also be cut to the desired dimensions and/or shape as needed via in-line methods. The filter media of the present invention provides a meltblown fiber nonwoven web which exhibits good abrasion resistance without significantly degrading the strength and/or filtration properties of the same. The term “nonwoven” fabric or web means a web having a structure of individual fibers or threads which are interlaid, but not in an identifiable manner as in a knitted or woven fabric. Nonwoven fabrics or webs have been formed by many processes such as for example, meltblowing processes, spunbonding processes, hydroentangling, air-laying, carded web processes, and so forth.

The first layer desirably comprises a nonwoven web of fine fibers or microfibers having an average fiber diameter of less than about 8 micrometers and more desirably having an average fiber diameter between about 0.5 micrometer and about 6 micrometers and still more desirably between about 3 micrometers and about 5 micrometers. The first layer desirably has a basis weight of at least 12 grams/square meter (g/m²) and more desirably has a basis weight between about 17 g/m² and about 175 g/m², and still more desirably between about 34 g/m² and about 100 g/m². Fine fibers can be made by various methods known in the art. Desirably the first layer comprises a nonwoven web of fine meltblown fibers.

Meltblown fibers are generally formed by extruding a molten thermoplastic material through a plurality of die capillaries as molten threads or filaments into converging high velocity air streams that attenuate the filaments of molten thermoplastic material to reduce their diameter. Thereafter, the meltblown fibers can be carried by the high velocity gas stream and are deposited on a collecting surface (collector screen) where they become entangled to form a web of randomly laid meltblown fibers. The collecting surface will preferably be a conveyor to facilitate continuous production of the meltblown fibers. Meltblown processes are disclosed, for example, in Naval Research Laboratory Report No. 4364, “Manufacture of Super-fine Organic Fibers” by V. A. Wendt, E. L. Boon, and C. D. Fluharty; Naval Research Laboratory Report No. 5265, “An Improved Device for the Formation of Super-fine Thermoplastic Fibers” by K. D. Lawrence, R. T. Lukas, and J. A. Young; U.S. Pat. No. 3,849,241; U.S. Pat. No. 4,100,324; U.S. Pat. No. 3,959,421; U.S. Pat. No. 5,652,048; and U.S. Pat. No. 4,526,733. The teachings of these references are incorporated by reference herein in their entirety for the purpose of teaching suitable methods for manufacturing nonwoven webs of polybutylene naphthalate fiber by meltblowing. The meltblown fiber layer can be formed by a single meltblown die or by consecutive banks of meltblown fiber dies by consecutively depositing the fibers over one another on a moving forming surface. Thus, although the term “layer” is used, one layer may in fact comprise several sublayers assembled to obtain the desired thickness and/or basis weight.

The macrofiber layer comprises larger fibers of sufficient number and size so to create an open structure having improved strength relative to the first fine fiber layer. Desirably the macrofiber layer has a significant number of fibers in excess of about 15 micrometers and still more desirably has a substantial number of fibers in excess of about 25 micrometers. In this regard, it is noted that the coarse fibers can comprise a plurality of smaller fibers having diameters between about 10 and about 35 micrometers and still more desirably an average fiber diameter of between about 12 micrometers and about 25 micrometers wherein the individual fibers “rope” or otherwise become length-wise bonded so as to collectively form large, unitary fibers or filaments. In calculating average fiber size, the length-wise bonded fibers are treated as a single fiber. The macrofiber layer desirably has a basis weight less than about 100 g/m² and more desirably has a basis weight between about 10 g/m² and about 70 g/m², and still more desirably between about 15 g/m² and about 35 g/m². In a further aspect, the basis weight ratio of the first layer of fine fibers to the second layer of macrofibers desirably ranges from about 2:1 to about 10:1 and in a preferred embodiment the ratio of the first layer of fine fibers to the second layer of coarse fibers is about 3.3:1.

The second layer of macrofibers can be made by meltblown processes and, desirably, the macrofibers can be deposited directly onto the fine fiber web in a semi-molten state such that the macrofibers bond directly and autogenously to the fine fiber web. The deposition of the macrofibers is such that they have sufficient latent heat to more effectively bond to each other as well as to the previously deposited fine fibers thereby creating a filter media having overall improved strength and/or abrasion resistance. Conventional meltblowing equipment can be used to produce such larger, coarse fibers by properly balancing the polymer throughput, diameter of the die tip orifice, formation height (i.e. the distance from the die tip to the forming surface), melt temperature and/or draw air temperature. As a specific example, the last bank in a series of meltblown fiber banks can be adjusted whereby the last meltblown bank makes and deposits a layer of macrofibers over the newly formed fine fiber nonwoven web. With regard to making larger thermoplastic polyester fibers, by reducing the primary air temperature and/or lowering the formation height, production of larger, coarse fibers is achieved. The thickness or basis weight of the macrofiber layer can be increased as desired by increasing the number of consecutive meltblown banks altered to provide larger, coarse fibers. It is noted that alteration of other parameters alone or in combination with the aforesaid parameters may also be used to achieve macrofiber layers and/or webs.

Methods of making such larger, coarse fibers are described in more detail in U.S. Pat. No. 4,659,609 and U.S. Pat. No. 5,639,541. The teachings of these references are incorporated herein for the purpose of describing suitable methods for manufacturing coarse fibers that are suitable for utilization in manufacturing the filters of this invention. Desirably, the macrofiber layer is deposited co-extensively with the fine fiber layer and adheres directly thereto. In this regard, it will be appreciated that the macrofibers are not significantly drawn and/or oriented nevertheless, since the macrofibers are deposited upon the fine fibers in a semi-molten state they form good inter-fiber bonds with the fine fibers as well as other coarse fibers and thereby provide a composite structure which has improved strength and resistance to pilling during handling, converting and/or use. Moreover, despite the formation of a layer having increased irregularity, polymeric globules and/or shot, the macrofiber layer forms an open structure that does not significantly decrease the filtration efficiency. It is possible and frequently advantageous to deposit more than one macrofiber layer on the fine fiber layer.

The multilayer nonwoven web of the present invention is autogenously bonded and does not necessarily require additional binding. The term “autogenous bonding” refers to inter-fiber bonding between discrete parts and/or surfaces independently of mechanical fasteners or external additives such as adhesives, solders, and the like. However, after the deposition of the layers, the layers can, optionally, be further bonded together to improve the overall integrity of the multilayer structure and/or to impart stiffness to the same. Whenever further bonding is desired it is preferred to employ a bond pattern affecting a minimal surface area of the material since filtration efficiency typically decreases as the bonding area increases. Thus, desirably the bond pattern employed does not bond more than about 10% of the surface area of the sheet and still more desirably the bond area comprises between 0.5% and about 5% of the surface area of the fabric. The multilayer laminate can be bonded by continuous or substantially continuous seams and/or discontinuous bonded regions. Preferably the multi-layered filter media materials are point bonded. As used herein “point bonded” or “point bonding” refers to bonding one or more layers of fabric at numerous small, discrete bond points. For example, thermal point bonding generally involves passing one or more layers to be bonded between heated rolls such as, for example, an engraved patterned roll and an anvil roll. The engraved roll is patterned in some way so that the entire fabric is not bonded over its entire surface, and the anvil roll is usually flat. Numerous bond patterns have been developed in order to achieve various functional and/or aesthetic attributes, and the particular nature of the pattern is not believed critical to the present invention. Exemplary bond patterns are described in U.S. Pat. No. 3,855,046, U.S. Design Pat. 356,688, and U.S. Pat. No. 5,620,779. These and other bond patterns can be modified as necessary to achieve the desired bonding area and frequency.

Meltblown filter laminates of the present invention are well suited for fluid filtration applications including liquid and gas filtration applications. The filter material will most commonly be employed as part of a filter assembly which can comprise the filter media, a flame and housing. As used herein the term frame is used in its broadest sense and includes, without limitation, edge frames, mesh supports, cartridges, and other forms of filter elements. The filter media will commonly be secured and/or supported by a frame. Often the frame is slideably engaged with the housing. The frame can be designed so as to be capable of being releasably engaged in the housing element such that the frame and corresponding filter media can be readily replaced as needed. As examples, the frame and/or housing can be adapted so that the frame can be manually rotated, screwed, bolted, snapped, slid or otherwise secured into position

The nonwoven filtration material can be used alone or as part of a laminate structure in combination with additional materials. As a particular example, the nonwoven fabric can be laminated with an additional filter material such as, for example, paper, other polyesters, membranes, battings, nonwovens, woven fabrics, cellular foams, and other filter and/or reinforcement filter material. Paper filter materials are available in a wide variety of grades and forms. As an example, the filter paper can comprise a cellulose-based paper containing a phenol-formaldehyde resin. The filtration efficiency of the filter paper can be modified as desired by selecting the amount and type of resin binders, cellulose fiber size or furnishings, processing parameters and other factors known to those skilled in the art.

In one embodiment of this invention polybutylene naphthalate fibers are used in conjunction with fibers of another polymer to make the nonwoven fiber web. For instance, such a nonwoven fiber web can contain fibers of polyolefins or other polyesters in addition to the polybutylene naphthalate fibers. Some representative examples additional fibers that can be used in making the nonwoven web include polypropylene fibers, polybutylene fibers, polyethylene terephthalate fibers, polyethylene naphthalate fibers, and polybutylene terephthalate fibers. The additional fibers will typically be polypropylene fibers or polybutylene terephthalate fibers. Such nonwoven fiber webs will normally contain from about 35 weight percent to about 95 weight percent polybutylene naphthalate fibers and from about 5 weight percent to about 65 weight percent fibers that are made from the other polymer. Such nonwoven fiber webs will typically contain from about 40 weight percent to about 90 weight percent polybutylene naphthalate fibers and from about 10 weight percent to about 60 weight percent fibers that are made from the other polymer. Such nonwoven fiber webs will more typically contain from about 50 weight percent to about 85 weight percent polybutylene naphthalate fibers and from about 15 weight percent to about 50 weight percent fibers that are made from the other polymer.

Melt blends of polybutylene naphthalate with other polyesters can also be utilized in manufacturing the nonwoven web of fibers. Some representative examples of other polyesters that can be blended with the polybutylene naphthalate include polyethylene terephthalate, polyethylene naphthalate, and polybutylene terephthalate. Polybutylene terephthalate is normally preferred for utilization in such blends. Melt blends of this type will normally contain from about 35 weight percent to about 95 weight percent polybutylene naphthalate and from about 5 weight percent to about 65 weight percent of the other polyester. Such melt blends will typically contain from about 40 weight percent to about 90 weight percent polybutylene naphthalate and from about 10 weight percent to about 60 weight percent of the other polyester and will more typically contain from about 50 weight percent to about 85 weight percent polybutylene naphthalate and from about 15 weight percent to about 50 weight percent of the other polyester.

The additional filtration material can be fixedly attached to the nonwoven filter media via one or more methods known to those skilled in the art. Desirably the paper filter is laminated to the nonwoven filter material via an adhesive. In this regard, the nonwoven material can be sprayed with an adhesive and then the paper filter and nonwoven filter superposed and pressed together such that they become permanently attached to one another. By applying the adhesive to the nonwoven the filtration efficiency of the paper filter material is not substantially degraded since only adhesive upon the fiber surface will contact the paper filter material thereby minimizing any loss in filtration efficiency. Alternately, the adhesive can be sprayed onto the filter paper and then the treated side of the filter paper and the nonwoven can be permanently attached to one another. In a particular aspect of the invention, depending on the grade of filter paper, the nonwoven/paper laminate can have a filtration efficiency of at least about 98% for 10 μ/m particles and in a further aspect can have a filtration efficiency of at least about 98% for 2 μm particles.

In some cases it is desirable for the filter media to be comprised of a fine fiber layer that is positioned between a macrofiber layer and a filter paper sheet. As a specific example, a paper filter sheet can be adhesively laminated to a 65 g/m² layer of fine fibers, comprising polybutylene naphthalate meltblown fibers, such that the paper filter adheres directly to one side of the fine fiber layer and the macrofiber layer adheres to the second or opposite side of the fine fiber layer. The macrofiber layer is also preferable comprised of polybutylene naphthalate and can have a basis weight of approximately 20 g/m². The filter material of this configuration is particularly well suited for use as a coalescing filter such as used in diesel engines and marine applications. The laminate prevents passage of both water and particles while allowing fuel to pass therethrough. The nonwoven fabric of polyester substantially prevents passage of water through the media and as well as large particles. The paper filter media further filters finer particles from the liquid being filtered, such as motor oil or fuel. Coalescing filter media are commonly employed within a frame and housing located either upstream or downstream of the liquid hydrocarbon pump.

The filter material of the present invention can optionally include various internal additives and/or topically applied treatments in order to impart additional or improved characteristics to the nonwoven fabric. Such additives and/or treatments are known in the art and include, for example, alcohol repellence treatments, wetting agents (i.e. compositions which improve or make a surface hydrophilic), anti-oxidants, stabilizers, fire retardants, disinfectants, anti-bacterial agents, anti-fungal, germicides, virucides, detergents, cleaners and so forth.

Air filters such as those described in U.S. Pat. No. 5,273,565 can be manufactured utilizing polybutylene naphthalate in accordance with this invention. The teachings of U.S. Pat. No. 5,273,565 are incorporated herein by reference. The meltblown nonwoven web used in manufacturing such air filters typically has the following characteristics: (1) an average fiber size diameter of 3.0 μm to 10 μm, (2) a coefficient of variation of the web fiber size diameter of 15 percent to 40 percent, (3) a packing density of 5 percent to 15 percent, and (4) a ratio of packing density to average fiber size diameter of 1.3 to 1.75.

This invention is illustrated by the following examples that are merely for the purpose of illustration and are not to be regarded as limiting the scope of the invention or the manner in which it can be practiced. Unless specifically indicated otherwise, parts and percentages are given by weight.

### EXAMPLE 1

Polybutylene naphthalate (PBN) that is suitable for use in manufacturing the filter media of this invention was synthesized in this experiment. A 50-gallon (189 liter) batch reactor with a helical agitator was employed in the synthesis of the PBN in this experiment. In the procedure utilized 42.3 kg 1,4-butanediol, 82 kg of dimethyl 2,6-naphthalate, and 19.34 g of tetra-n-butyl titanate were charged into the reactor while the reactor was purged with dry nitrogen. The reactor was heated to a temperature of 215° C. The ester-interchange reaction was considered to be complete when more than 95% of the theoretical methanol had been collected. Then, the reactor temperature was increased to 255° C. while the reactor pressure was gradually reduced to 0.1 mm Hg over a period of 50 minutes. The polymerization mass was agitated at 250-260° C. at a pressure of 0.04 mm Hg until a specific agitator torque was reached. The polymer melt mass was subsequently extruded and cut into pellets. About 90 kg of PBN having an intrinsic viscosity of 0.54 dl/g was obtained.

### EXAMPLE 2

In this experiment the filtration efficiency of air filters made utilizing a nonwoven web of polybutylene naphthalate (PBN) and a blend containing 50 weight percent PBN and 50 weight percent PBT were compared to an air filter made utilizing a nonwoven web of polybutylene terephthalate (PBT) that was otherwise identical. The nonwoven webs utilized in manufacturing these filters were made by a meltblowing procedure that was operated utilizing the conditions shown in Table 1.

TABLE 1

| Meltblow Parameter | Setting |
|---|---|
| DCD (Die to Collector | 3-10 in (7.5 to 25 cm) for fine fiber |
| Distance) | diameter (0.5 to 3 micrometers) |
| Quench Air | As Necessary |
| Output | Up to 1.0 grams/hole/minute |
| Extruder Profile | |
| Zone 1 | 250° C. to 260° C. |
| Zone 2 | 260° C. to 270° C. |
| Zone 3 | 270° C. to 285° C. |
| Zone 4 | 285° C. to 290° C. |
| Zone 5 | 290° C. to 295° C. |
| Die Melt Temperature | 295° C. to 310° C. |
| Process Air Temperature | 310° C. to 360° C. |
| Process Air Flow Rate | 1100-2400 lbs./hour (2420-5280 kg/hour) |
| Conveyor Vacuum | 10-20 inches (25.4-50.8 cm) of H₂O |
| Extruder Outlet Pressure | 500-600 p.s.i. (3400-4100 kPa) |

The air filters made were then evaluated to determine filtration efficiency. The filter media s made with the PBN, PBT, and the blend of PBN and PBT were tested for filter efficiency at three stages: (1) as made (uncharged), (2) after charging, and (3) after heat treatment of the charged media in hot air at a temperature of 130° C. for 1 hour. Table 2 reports the filter efficiency retention after exposure to the hot air treatment. The filtration efficiency retentions are reported as a percentage of the charged filter efficiency before being exposed to the hot air. The filtration efficiency of the filters evaluated was also determined in the uncharged state and after being charged. Table 2 also reports the ratio of charged heat-treated efficiency to uncharged efficiency.

TABLE 2

| | Condition | | |
|---|---|---|---|
| | | 50%/50% | |
| | PBN | PBN/PBT Blend | PBT |
| Filtration Efficiency | 83% | 60% | 44% |
| Retention After Heat | | | |
| Treatment | | | |
| Ratio of Charged | 3.42 | 1.46 | 1.17 |
| Heat Treated | | | |
| Efficiency to | | | |
| Uncharged Efficiency | | | |

As can be seen from Table 2, the filter made with the PBN nonwoven web retained a much higher of filtration efficiency after the heat treatment process than did the filter made with the PBT nonwoven web. It should also be noted that the filter made with the PBN nonwoven fiber web also exhibited a much higher ratio of charged to uncharged filtration efficiency after being subjected to the heat treatment procedure. This experiment accordingly shows the unexpected benefit that PBN offers over PBT in making nonwoven fiber web for air filters.

The filter made with the blend of PBN and PBT also offered improved filtration efficiency over the filter made using pure PBT. Accordingly, this experiment also shown that blends of PBN and PBT can be used in making nonwoven fiber webs for air filters for use in less demanding applications.

### EXAMPLE 3

In this experiment PBN was evaluated to determine its resistance to various fuels and was compared to the fuel resistance of PBT. In the procedure used PBN and PBT was injection molded into tensile test bars. The tensile test bars were then soaked in various fuels at 65° C. for either 2000 hours or 5000 hours. The yield strength and modulus of the PBT and PBN test bars were then determined and are reported in Table 3 and Table 4, respectively.

TABLE 3

| | | Fuel A | Fuel B | Fuel C | Fuel D |
|---|---|---|---|---|---|
| | | % | % | % | % |
| | Soak Time | Retention | Retention | Retention | Retention |
| | Hours at | Yield | Yield | Yield | Yield |
| Polymer | 65° C. | Strength | Strength | Strength | Strength |
| PBN | 2000 | 109 | 82 | 102 | 107 |
| | 5000 | 105 | 12 | 88 | 95 |
| PBT | 2000 | 73 | 59 | 61 | 69 |
| | 5000 | 43 | 53 | 63 | 71 |

TABLE 4

| | | Fuel A | Fuel B | Fuel C | Fuel D |
|---|---|---|---|---|---|
| | Soak Time | % | % | % | % |
| | Hrs, at | Retention | Retention | Retention | Retention |
| Polymer | 65 C. | Modulus | Modulus | Modulus | Modulus |
| PBN | 2000 | 107 | 83 | 95 | 109 |
| | 5000 | 104 | 1 | 89 | 102 |
| PBT | 2000 | 26 | 15 | 16 | 19 |
| | 5000 | 10 | 22 | 20 | 23 |

Soak Fuels:
1) Fuel A: 50% Toluene+50% Isooctane,
2) Fuel B: Fuel “A”+15% Methanol+Aggressive Water
3) Fuel C: Fuel “A”+22% Ethanol+Aggressive Water
4) Fuel D: Fuel “A”+85% Ethanol+Aggressive Water
   The water used in this series of experiments was deemed to be “aggressive” by virtue of the fact that it contained peroxides.

As can be determined from Table 3, the PBN test bars exhibited good resistance to ethanol based fuels. In fact, the resistance of the PBN to ethanol based fuels proved to be superior to that of PBT after being soaked in the fuel for either 2000 hours or 5000 hours. This experiment shows that PBN offers good fuel resistance for utilization in fuel filters that are used for filtering ethanol based fuels.

While certain representative embodiments and details have been shown for the purpose of illustrating the subject invention, it will be apparent to those skilled in this art that various changes and modifications can be made therein without departing from the scope of the subject invention.

What is claimed is:

1. A filtration media that is comprised of nonwoven web of fibers having an average diameter which is within the range of about 0.5 microns to about 35 microns, wherein the fibers are comprised of polybutylene naphthalate having an intrinsic viscosity which is within the range of 0.3 to 0.7 dl/g as measured in o-chlorophenol at 35° C.

2. The filtration media as specified in claim 1 wherein the polybutylene naphthalate has an intrinsic viscosity which is within the range of 0.4 to 0.6 dl/g as measured in o-chlorophenol at 35° C.

3. The filtration media as specified in claim 1 wherein the fibers have an average diameter which is within the range of about 0.5 microns to about 20 microns.

4. The filtration media as specified in claim 1 wherein the fibers have an average diameter which is within the range of about 0.5 microns to about 6 microns.

5. The filtration media as specified in claim 1 wherein the fibers have an average diameter which is within the range of about 3 microns to about 5 microns.

6. The filtration media as specified in claim 1 wherein the filtration media includes at least one layer of fine fibers having an average diameter which is within the range of about 0.5 microns to about 8 microns and at least one layer of coarse fibers having an average diameter which is within the range of about 10 microns to about 35 microns.

7. The filtration media as specified in claim 6 wherein the weight ratio of fine fibers to coarse fibers is within the range of 2:1 to 10:1.

8. The filtration media as specified in claim 6 wherein the fine fibers have an average diameter which is within the range of about 1 microns to about 6 microns and wherein the coarse fibers have an average diameter which is within the range of about 10 microns to about 30 microns.

9. A filter comprising a rigid frame having the filtration media specified in claim 1 fixedly attached thereto.

10. The filter as specified in claim 9 wherein the rigid frame is comprised of polybutylene naphthalate having an intrinsic viscosity which is within the range of 0.3 dl/g to 1.5 dl/g as measured in o-chlorophenol at 35° C.

11. The filter as specified in claim 9 wherein the rigid frame is comprised of polybutylene naphthalate having an intrinsic viscosity which is within the range of 0.6 dl/g to 1.2 dl/g as measured in o-chlorophenol at 35° C.

12. A filter comprising: a frame having a nonwoven filter material fixedly attached thereto; said nonwoven filter material comprising (i) a first layer of polybutylene naphthalate microfibers having an average fiber size of less than about 8 micrometers and (ii) a second layer comprising polybutylene naphthalate fibers having fibers having an average fiber size in excess of 12 micrometers and wherein said second layer is autogenously bonded to said first layer, wherein said second layer has a basis weight of less than 34 g/m2, and wherein the polybutylene naphthalate has an intrinsic viscosity which is within the range of 0.3 to 0.7 dl/g as measured in o-chlorophenol at 35° C.

13. The filter of claim 12 wherein said second layer comprises meltblown fibers.

14. The filter of claim 12 wherein said second layer includes lengthwise-bonded fibers.

15. The filter of claim 12 wherein said first layer of microfibers comprises meltblown fibers having a basis weight between 17 g/m2 and 300 g/m2 and wherein said first layer of microfibers have an average fiber diameter between about 0.5 micrometers and about 6 micrometers.

16. The filter of claim 12 wherein the basis weight ratio of the first layer to the second layer is between 2:1 and 10:1

17. The filter of claim 1 further comprising a filter paper sheet laminated to the nonwoven filter material.

18. The filter of claim 17 wherein a filter paper sheet is laminated to the first layer of the nonwoven filter material.

19. The filter of claim 1 wherein said first and second layers of the nonwoven filter material both comprise meltblown thermoplastic polyester fibers and wherein said first layer has a basis weight between 34 g/m2 and about 175 g/m2.

20. The filter of claim 13 wherein said nonwoven filter material further comprises a third layer of meltblown fibers having an average diameter in excess of about 12 micrometers, wherein said third layer is autogenously bonded to said first layer, and wherein the third layer of meltblown fibers is comprised of polybutylene naphthalate having an intrinsic viscosity which is within the range of 0.3 to 0.7 dl/g as measured in o-chlorophenol at 35° C.

21. The filter of claim 20 wherein said third layer has a basis weight less than 34 g/m2.

22. The filter of claim 21 wherein said first layer has a basis weight between about 34 g/m2 and 150 g/m2.

23. The filter of claim 22 wherein a filter paper sheet is laminated to the nonwoven filter material.

24. A process for manufacturing filter media which comprises (1) extruding molten polybutylene naphthalate through a plurality of die capillaries as molten filaments into converging high velocity gas streams that attenuate the filaments to reduce their diameter to within the range of about 0.5 microns to about 35 microns, wherein the polybutylene naphthalate has an intrinsic viscosity which is within the range of 0.3 to 0.7 dl/g as measured in o-chlorophenol at 35° C., (2) collecting the filaments on a conveyor wherein they become entangled to form a nonwoven web, and (3) allowing the entangled nonwoven web to solidify to produce a nonwoven web of the filter media.

25. The process as specified in claim 24 wherein the polybutylene naphthalate has an intrinsic viscosity which is within the range of 0.4 to 0.6 dl/g as measured in o-chlorophenol at 35° C.

26. The process as specified in claim 24 wherein the fibers have an average diameter which is within the range of about 0.5 microns to about 20 microns.

27. The process as specified in claim 24 wherein the fibers have an average diameter which is within the range of about 0.5 microns to about 6 microns.

28. The process as specified in claim 24 wherein the fibers have an average diameter which is within the range of about 3 microns to about 5 microns.

29. The filtration media specified in claim 1 wherein the web of fibers is further comprised of additional polymer fibers that are comprised of a polymer other than polybutylene naphthalate.

30. The filtration media specified in claim 29 wherein the additional fibers are polypropylene fibers.

31. The filtration media specified in claim 29 wherein the additional fibers are polybutylene terephthalate fibers.
